(19) United States
(12) Patent Application Publication
(10) Pub. No.: US 2006/0144274 A1
(43) Pub. Date: Jul. 6, 2006

(54) Imprint lithography

(75) Inventors: Aleksey Yurievich Kolesnychenko, Helmond (NL); Helmar Van Santen, Amsterdam (NL); Yvonne Kruijt-Stegeman, Eindhoven (NL); Erik Roelof Loopstra, Heeze (NL)

Correspondence Address: PILLSBURY WINTHROP SHAW PITTMAN, LLP, P.O. BOX 10500, MCLEAN, VA, 22102, US

(73) Assignee: ASML NETHERLANDS B.V., Veldhoven (NL)

(21) Appl. No.: 11/025,600

(22) Filed: Dec. 30, 2004

(51) Int. Cl. B41F 33/00

(52) U.S. Cl. 101/483

(57) ABSTRACT

An imprinting method is disclosed, in which an embodiment involves subjecting an imprintable medium on a substrate to conditions such that the medium is at a first temperature so that it is in a flowable state, the imprintable medium comprising an imprint material selected from a group consisting of: a crystalline material and a polycrystalline material, pressing a template into the medium to form an imprint in the medium, cooling the medium to a second temperature such that the medium is in a substantially non-flowable state while the medium is contacted by the template, and separating the template from the medium while in the substantially non-flowable state.

### FIELD

The invention relates to imprint lithography.

### BACKGROUND

A lithographic apparatus is a machine that applies a desired pattern onto a target portion of a substrate. Lithographic apparatus are conventionally used, for example, in the manufacture of integrated circuits (ICs), flat panel displays and other devices involving fine structures.

It is desirable to reduce the size of features in a lithographic pattern because this allows for a greater density of features on a given substrate area. In photolithography, the increased resolution may be achieved by using radiation of a short wavelength. However, there are problems associated with such reductions. Lithographic apparatus using 193 nm wavelength radiation are starting to be adopted but even at this level, diffraction limitations may become a barrier. At lower wavelengths, the transparency of projection system materials is poor. Thus, optical lithography capable of enhanced resolution will likely require complex optics and rare materials and thus will be expensive.

An alternative method to printing sub-100 nm features, known as imprint lithography, comprises transferring a pattern to a substrate by imprinting a pattern into an imprintable medium using a physical mould or template. The imprintable medium may be the substrate or a material coated onto a surface of the substrate. The imprintable medium may be functional or may be used as a “mask” to transfer a pattern to an underlying surface. The imprintable medium may, for instance, be provided as a resist deposited on a substrate, such as a semiconductor material, to which the pattern defined by the template is to be transferred. Imprint lithography is thus essentially a moulding process on a micrometer or nanometer scale in which the topography of a template defines the patterns created on a substrate. Patterns may be layered as with optical lithography processes so that in principle imprint lithography could be used for such applications as integrated circuit manufacture.

The resolution of imprint lithography is limited only by the resolution of the template fabrication process. For instance, imprint lithography has been used to produce features in the sub-50 nm range with good resolution and line edge roughness. In addition, imprint processes may not require the expensive optics, advanced illumination sources or specialized resist materials typically required for optical lithography processes.

### SUMMARY

According to an aspect of the invention, there is provided an imprinting method, comprising:

subjecting an imprintable medium on a substrate to conditions such that the medium is at a first temperature so that it is in a flowable state, the imprintable medium comprising an imprint material selected from a group consisting of: a crystalline material and a polycrystalline material;

pressing a template into the medium to form an imprint in the medium;

cooling the medium to a second temperature such that the medium is in a substantially non-flowable state while the medium is contacted by the template; and

separating the template from the medium while in the substantially non-flowable state.

References to crystalline materials and polycrystalline materials are to be interpreted in accordance with their generally accepted meaning in the appropriate technical field. In particular, these terms do not encompass amorphous or glassy materials. In contrast to amorphous materials, crystalline and polycrystalline materials exhibit sharp phase transitions at well defined temperatures due to their generally regular atomic structure. Thus, the temperature change required to switch a crystalline or polycrystalline material between non-flowable or solid (non-printable) and flowable or liquid (printable) states is far smaller than that required to switch an amorphous material between its glassy and free flowing states. Consequently, the temperature changes required to prepare a crystalline or polycrystalline material for imprinting and subsequently for removal of the template are significantly lower than those required for the analogous steps when using a thermoplastic polymer. As a result, heat flow and differential thermal expansion within the imprinting system may be reduced thereby potentially improving the accuracy of imprint overlay. Since a large temperature change may not be required, the rate at which imprinting may be carried out should also be increased. Furthermore, since crystalline and polycrystalline materials exhibit well defined melting points, transitions between the solid and liquid states should be more accurately reproducible and more accurately tailorable to suit a given application.

In an embodiment, the medium is heated to the first temperature (e.g., less than 1 minute or less than 10 seconds) before the template is pressed into the medium. The medium may be heated to the first temperature (e.g., less than 1 minute or less than 10 seconds) after the medium is contacted by the template. Heating may be provided by exposure to radiation from a suitable radiation source or by the passage of an electric current.

In an embodiment, a first volume of the medium is deposited on a first target portion of the substrate. It is thus possible to imprint a volume of the imprintable medium when provided at a specific target location on the substrate surface. In an embodiment, following imprinting of the first volume of the medium, a second volume of the medium is deposited on a second target portion of the substrate which is spaced from the first target portion and the second volume of the medium is imprinted. It is therefore possible to utilize the method in a step and repeat process which may minimize pattern distortions and CD variations making this embodiment suited to manufacture of devices requiring high overlay accuracy.

In an embodiment, the first temperature is equal to or greater than the melting point temperature of the medium. The first temperature may be up to 10° C., up to 5° C. or up to 3° C. above the melting point temperature of the medium.

In an embodiment, the second temperature is equal to or less than the melting point temperature of the medium. The second temperature may be up to 10° C., up to 5° C. or up to 3° C. below the melting point temperature of the medium.

In an embodiment, the medium is in a liquid phase when the template initially contacts the medium. The medium may be in a solid phase immediately before the template is separated from the medium. For example, the medium may be in a solid phase up to 5 minutes, up to 3 minutes or up to 1 minute before the template is separated from the medium. In an embodiment, the medium is converted from a liquid phase to a solid phase while the medium is contacted by the template.

The medium can be dispensed as a flowable droplet on to the substrate surface and then either cooled and allowed to solidify prior to contacting by the template, or contacted by the template while still in a flowable state. An embodiment of the invention may therefore be employed in a drop on demand process. In certain applications, the medium may be provided on the substrate by a method selected from a group consisting of: casting, spray coating and spin coating. When appropriate, the medium may be provided as liquid streaks. When spin coating is used it will be appreciated that the medium will generally be provided as a thin layer.

A pressure of less than 1 Mpa, less than 0.5 Mpa or less than 0.1 MPa may be applied to the template during contacting the medium with the template. In an embodiment, a pressure in the range of 10 to 100 kPa, 30 to 80 kPa, or 50 to 60 kPa is applied to the template during contacting the medium with the template. Since many crystalline and polycrystalline materials exhibit low viscosities relatively low pressures may be used to imprint the medium thereby helping to avoid problems related to deformation of the medium and/or substrate caused by using high pressures.

In an embodiment, the method comprises contacting the imprintable medium with the template forms an area of reduced thickness in the imprintable medium and etching the area of reduced thickness to expose a region of a surface of the substrate. In an embodiment, the method further comprises etching the exposed region of the surface of the substrate.

In an embodiment, an intermediate layer, such as a planarization and transfer layer, is provided between the substrate and the imprintable medium. In an embodiment, the method comprises contacting the imprintable medium with the template forms an area of reduced thickness in the imprintable medium and etching the area of reduced thickness to expose a region of a surface of the intermediate layer. Appropriately, the method may further comprise etching the exposed region of the surface of the intermediate layer to expose a region of a surface of the substrate. Conveniently, the method may further comprise etching the exposed region of the surface of the substrate.

According to an aspect of the invention, there is provided a method for patterning a substrate, comprising:

subjecting an etch barrier material on a substrate to conditions such that the etch barrier material is at a first temperature so it is in a flowable state, the etch barrier material comprising an imprint material selected from a group consisting of: a crystalline material and a polycrystalline material;

pressing a template into the etch barrier material to form a pattern comprising an area of reduced thickness in the etch barrier material;

cooling the etch barrier material to a second temperature such that the etch barrier material is in a substantially non-flowable state while the etch barrier material is contacted by the template;

separating the template from the etch barrier material while in the substantially non-flowable state;

etching the area of reduced thickness to expose a region of a surface of the substrate; and

etching the exposed region of the surface of the substrate.

In an embodiment, the etch barrier material is heated to the first temperature (e.g., less than 1 minute or less than 10 seconds) before the template is pressed into the etch barrier material. The etch barrier material may be heated to the first temperature (e.g., less than 1 minute or less than 10 seconds) after the etch barrier material is contacted by the template. Heating may be provided by exposure to radiation from a suitable radiation source or by the passage of an electric current.

In an embodiment, the etch barrier material is dispensed as a flowable droplet on to the substrate surface and then either cooled and allowed to solidify prior to contacting by the template, or contacted by the template while still in a flowable state. This embodiment may therefore be employed in a drop on demand process. In certain applications the etch barrier material may be provided on the substrate by a method selected from a group consisting: of casting, spray coating and spin coating. When appropriate, the etch barrier material may be provided as liquid streaks. When spin coating is used it will be appreciated that the etch barrier material will generally be provided as a thin layer.

In an embodiment, a first volume of the etch barrier material is deposited on a first target portion of the substrate. It is thus possible to imprint a volume of the etch barrier material when provided at a specific target location on the substrate surface. In an embodiment, following etching of the surface of the first target portion of the substrate, a second volume of the etch barrier material is deposited on a second target portion of the substrate which is spaced from the first target portion and the surface of the second target portion of the substrate is etched. It is therefore possible to utilize a step and repeat process making this embodiment suited to manufacture of devices requiring high overlay accuracy.

In an embodiment, the first temperature is equal to or greater than the melting point temperature of the etch barrier material. The first temperature may be up to 10° C., up to 5° C. or up to 3° C. above the melting point temperature of the etch barrier material.

In an embodiment, the second temperature is equal to or less than the melting point temperature of the etch barrier material. The second temperature may be up to 10° C., up to 5° C. or up to 3° C. below the melting point temperature of the etch barrier material.

In an embodiment, the etch barrier material is in a liquid phase when the template initially contacts the etch barrier material. The etch barrier material may be in a solid phase immediately before the template is separated from the etch barrier material. For example, the etch barrier material may be in a solid phase up to 5 minutes, up to 3 minutes or up to 1 minute before the template is separated from the etch barrier material. In an embodiment, the etch barrier material is converted from a liquid phase to a solid phase while the etch barrier material is contacted by the template.

In an embodiment, a pressure of less than 1 Mpa, less than 0.5 Mpa or less than 0.1 MPa may be applied to the template during contacting the etch barrier material with the template. In an embodiment, a pressure in the range of 10 to 100 kPa, 30 to 80 kPa, or 50 to 60 kPa is applied to the template during contacting the etch barrier material with the template. Since many crystalline and polycrystalline materials exhibit low viscosities, relatively low pressures may be used to imprint the etch barrier material thereby helping to avoid problems related to deformation of the etch barrier material and/or substrate caused by using high pressures.

According to an aspect of the invention, there is provided an imprintable medium comprising a crystalline imprint material for use in an imprint lithography process.

According to an aspect of the invention, there is provided an imprintable medium comprising a polycrystalline imprint material for use in an imprint lithography process.

In relation to any of the above aspects of the invention, the imprint material may have a melting point temperature close to room temperature, i.e., around 20° C. In an embodiment, the imprint material may have a melting point temperature in the range of 10 to 100° C., 30 to 80° C. or 40 to 70° C.

In an embodiment, the imprint material has a viscosity of less than 100 cps, less than 70 cps or less than 10 cps, when measured at 25° C. An advantage of using a crystalline or polycrystalline imprint material is that many exhibit relatively low viscosities which is desirable in an imprintable medium, such as an etch barrier material. In an embodiment, the latent heat of fusion of the imprint material is less than 150 J/g, less than 100 J/g or less than 50 J/g.

The imprint material should exhibit an appropriate degree of etch resistance during the etching step(s), which will be at least partially dependent upon the etch conditions used in a particular process. Thus, in an embodiment, the imprint material comprises silicon containing groups.

In an embodiment, the imprint material comprises a hydrocarbon compound. The hydrocarbon compound may contain at least 15 carbon atoms. Moreover, the hydrocarbon compound may contain 15 to 40 carbon atoms, 20 to 35 carbon atoms or 25 to 30 carbon atoms. The hydrocarbon compound may be selected from the group consisting of: an aliphatic hydrocarbon, a branched hydrocarbon, an alicyclic hydrocarbon and an aromatic hydrocarbon. The hydrocarbon may be an alkane. The hydrocarbon may or may not be substituted and may or may not contain one or more heteroatom, such as oxygen, nitrogen or sulfur.

In embodiment, the imprint material comprises a paraffin wax, which may have a melting point temperature in the range of 20 to 90° C., 30 to 80° C. or 40 to 70° C. The paraffin wax may be represented by the formula CₙH₂ₙ₊₂ where 15≦n≦40, 20≦n≦35 or 25≦n≦30.

In an embodiment, the imprint material comprises a microcrystalline wax, which may have a melting point temperature in the range of 40 to 110° C., 50 to 100° C. or 60 to 90° C. The microcrystalline wax may be represented by the formula CₙH₂ₙ₊₂ where 15≦n≦40, 20≦n≦35 or 25≦n≦30.

In an embodiment, the imprintable medium or etch barrier material comprises a nucleating species selected from the group consisting of: an oxide, a nitride, a halide and a hydroxide. In an embodiment, the nucleating species is selected from the group consisting of: Al₂O₃, BN, KBr, CaBr₂.6H₂O, Na₂[B₄O₅(OH)₄].10H₂O, BaO, NiCl₂.6H₂O, Ba(OH)₂ and BA(OH)₂.8H₂O.

### BRIEF DESCRIPTION OF THE DRAWINGS

Embodiments of the invention will now be described, by way of example only, with reference to the accompanying schematic drawings in which corresponding reference symbols indicate corresponding parts, and in which:

FIGS. 1a-1c illustrate examples of soft, hot and UV lithography process respectively;

FIG. 2 illustrates a two step etching process employed when hot and UV imprint lithography is used to pattern a resist layer;

FIG. 3 illustrates relative dimensions of template features compared to the thickness of a typical imprintable resist layer deposited on a substrate;

FIGS. 4a-c are schematic representations of the initial three steps involved in a method in accordance with an embodiment of the invention to provide a patterned substrate; and

FIGS. 5a-d are schematic representations of the final four steps involved in a method in accordance with an embodiment of the invention to provide a patterned substrate.

### DETAILED DESCRIPTION

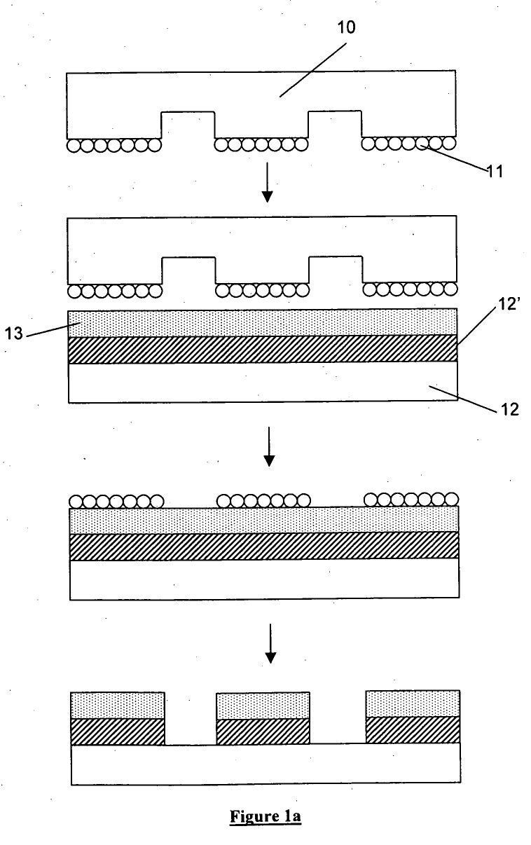

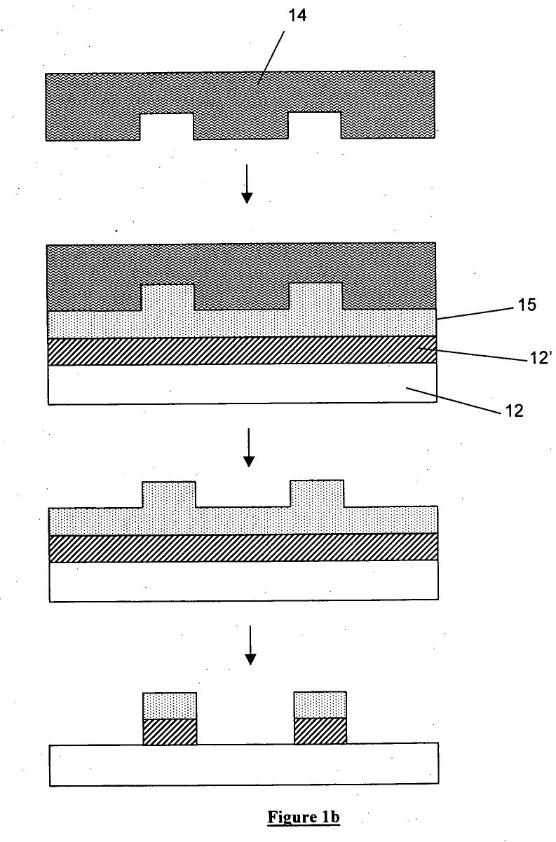

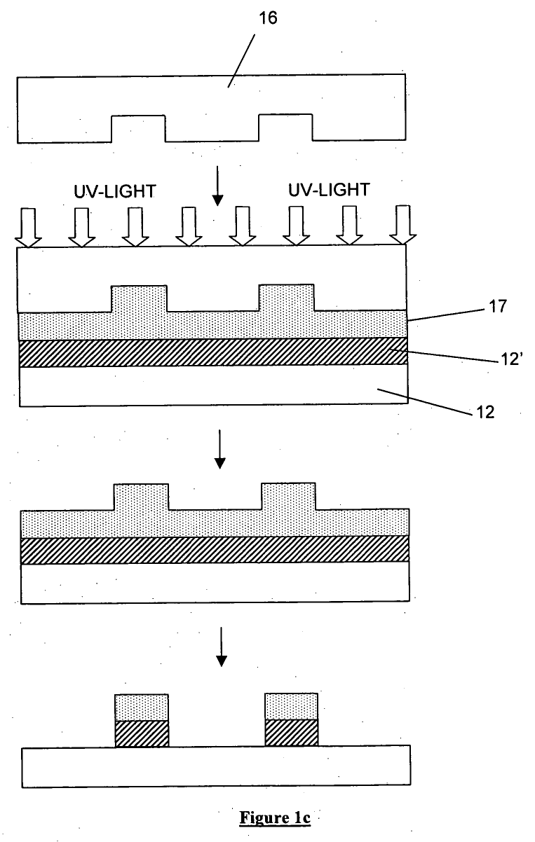

There are two principal approaches to imprint lithography which will be termed generally as hot imprint lithography and UV imprint lithography. There is also a third type of “printing” lithography known as soft lithography. Examples of these are illustrated in FIGS. 1a to 1c.

FIG. 1a schematically depicts the soft lithography process which involves transferring a layer of molecules 11 (typically an ink such as a thiol) from a flexible template 10 (typically fabricated from polydimethylsiloxane (PDMS)) onto a resist layer 13 which is supported upon a substrate 12 and planarization and transfer layer 12′. The template 10 has a pattern of features on its surface, the molecular layer being disposed upon the features. When the template is pressed against the resist layer, the layer of molecules 11 stick to the resist. Upon removal of the template from the resist, the layer of molecules 11 stick to the resist, the residual layer of resist is etched such that the areas of the resist not covered by the transferred molecular layer are etched down to the substrate.

The template used in soft lithography may be easily deformed and may therefore not be suited to high resolution applications, e.g. on a nanometer scale, since the defonnation of the template may adversely affect the imprinted pattern. Furthermore, when fabricating multiple layer structures, in which the same region will be overlaid multiple times, soft imprint lithography may not provide overlay accuracy on a nanometer scale.

Hot imprint lithography (or hot embossing) is also known as nanoimprint lithography (NIL) when used on a nanometer scale. The process uses a harder template made from, for example, silicon or nickel, which are more resistant to wear and deformation. This is described for instance in U.S. Pat. No. 6,482,742 and illustrated in FIG. 1b. In a typical hot imprint process, a solid template 14 is imprinted into a thermosetting or a thermoplastic polymer resin 15, which has been cast on the surface of substrate. The resin may, for instance, be spin coated and baked onto the substrate surface or more typically (as in the example illustrated) onto a planarization and transfer layer 12′. It should be understood that the term “hard” when describing an imprint template includes materials which may generally be considered between “hard” and “soft” materials, such as for example “hard” rubber. The suitability of a particular material for use as an imprint template is determined by its application requirements.

When a thermosetting polymer resin is used, the resin is heated to a temperature such that, upon contact with the template, the resin is sufficiently flowable to flow into the pattern features defined on the template. The temperature of the resin is then increased to thermally cure (e.g. crosslink) the resin so that it solidifies and irreversibly adopts the desired pattern. The template may then be removed and the patterned resin cooled.

Examples of thermoplastic polymer resins used in hot imprint lithography processes are poly (methyl methacrylate), polystyrene, poly (benzyl methacrylate) or poly (cyclohexyl methacrylate). The thermoplastic resin is heated so that it is in a freely flowable state immediately prior to imprinting with the template. It is typically necessary to heat thermoplastic resin to a temperature considerably above the glass transition temperature of the resin. The template is pressed into the flowable resin and sufficient pressure is applied to ensure the resin flows into all the pattern features defined on the template. The resin is then cooled to below its glass transition temperature with the template in place whereupon the resin irreversibly adopts the desired pattern. The pattern will consist of the features in relief from a residual layer of the resin which may then be removed by an appropriate etch process to leave only the pattern features.

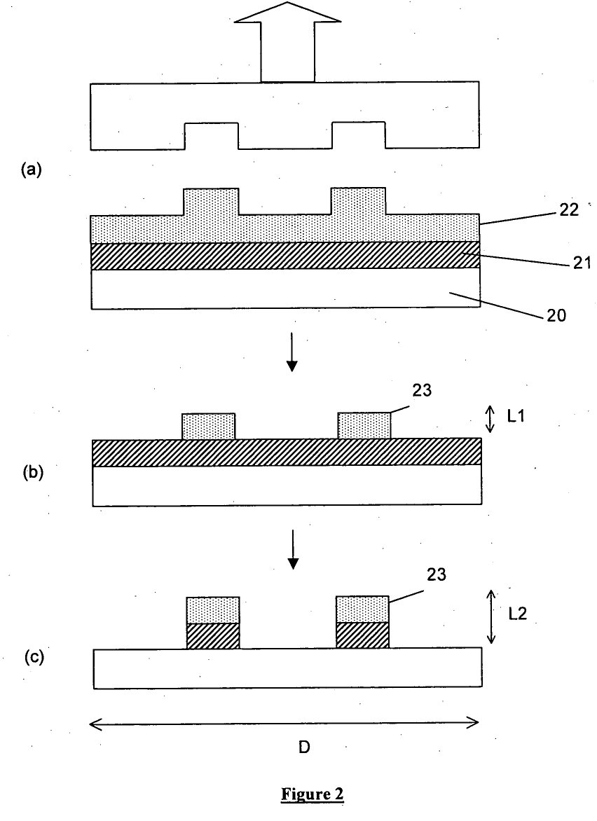

Upon removal of the template from the solidified resin, a two-step etching process is typically performed as illustrated in FIGS. 2a to 2c. The substrate 20 has a planarization and transfer layer 21 immediately upon it, as shown in FIG. 2a. The purpose of the planarization and transfer layer is twofold. It acts to provide a surface substantially parallel to that of the template, which helps ensure that the contact between the template and the resin is parallel, and also to improve the aspect ratio of the printed features, as will be described below.

After the template has been removed, a residual layer 22 of the solidified resin is left on the planarization and transfer layer 21, shaped in the desired pattern. The first etch is isotropic and removes parts of the residual layer 22, resulting in a poor aspect ratio of features where L1 is the height of the features 23, as shown in FIG. 2b. The second etch is anisotropic (or selective) and improves the aspect ratio. The anisotropic etch removes those parts of the planarization and transfer layer 21 which are not covered by the solidified resin, increasing the aspect ratio of the features 23 to (L2/D), as shown in FIG. 2c. The resulting polymer thickness contrast left on the substrate after etching can be used as for instance a mask for dry etching if the imprinted polymer is sufficiently resistant, for instance as a step in a lift-off process.

Hot imprint lithography suffers from a disadvantage in that not only must the pattern transfer be performed at a higher temperature, but also relatively large temperature differentials might be required in order to ensure the resin is adequately solidified before the template is removed. Temperature differentials between 35 and 100° C. may be needed. Differential thermal expansion between, for instance, the substrate and template may then lead to distortion in the transferred pattern. This may be exacerbated by the relatively high pressure required for the imprinting step, due the viscous nature of the imprintable material, which can induce mechanical deformation in the substrate, again distorting the pattern.

UV imprint lithography, on the other hand, does not involve such high temperatures and temperature changes nor does it require such viscous imprintable materials. Rather, UV imprint lithography involves the use of a partially or wholly transparent template and a UV-curable liquid, typically a monomer such as an acrylate or methacrylatee. In general, any photopolymerisable material could be used, such as a mixture of monomers and an initiator. The curable liquid may also, for instance, include a dimethyl siloxane derivative. Such materials are less viscous than the thermosetting and thermoplastic resins used in hot imprint lithography and consequently move much faster to fill template pattern features. Low temperature and low pressure operation also favors higher throughput capabilities.

An example of a UV imprint process is illustrated in FIG. 1c. A quartz template 16 is applied to a UV curable resin 17 in a similar manner to the process of FIG. 1b. Instead of raising the temperature as in hot embossing employing thermosetting resins, or temperature cycling when using thermoplastic resins, UV radiation is applied to the resin through the quartz template in order to polymerise and thus cure it. Upon removal of the template, the remaining steps of etching the residual layer of resist are the same or similar as for the hot embossing process described above. The UV curable resins typically used have a much lower viscosity than typical thermoplastic resins so that lower imprint pressures can be used. Reduced physical deformation due to the lower pressures, together with reduced deformation due to high temperatures and temperature changes, makes UV imprint lithography suited to applications requiring high overlay accuracy. In addition, the transparent nature of UV imprint templates can accommodate optical alignment techniques simultaneously to the imprinting.

Although this type of imprint lithography mainly uses UV curable materials, and is thus generically referred to as UV imprint lithography, other wavelengths of radiation may be used to cure appropriately selected materials (e.g., activate a polymerization or cross linking reaction). In general, any radiation capable of initiating such a chemical reaction may be used if an appropriate imprintable material is available. Alternative “activating radiation” may, for instance, include visible light, infrared radiation, x-ray radiation and electron beam radiation. In the general description above, and below, references to UV imprint lithography and use of UV radiation are not intended to exclude these and other activating radiation possibilities.

As an alternative to imprint systems using a planar template which is maintained substantially parallel to the substrate surface, roller imprint systems have been developed. Both hot and UV roller imprint systems have been proposed in which the template is formed on a roller but otherwise the imprint process is very similar to imprinting using a planar template. Unless the context requires otherwise, references to an imprint template include references to a roller template.

There is a particular development of UV imprint technology known as step and flash imprint lithography (SFIL) which may be used to pattern a substrate in small steps in a similar maimer to optical steppers conventionally used, for example, in IC manufacture. This involves printing small areas of the substrate at a time by imprinting a template into a UV curable resin, ‘flashing’ UV radiation through the template to cure the resin beneath the template, removing the template, stepping to an adjacent region of the substrate and repeating the operation. The small field size of such step and repeat processes may help reduce pattern distortions and CD variations so that SFIL may be particularly suited to manufacture of IC and other devices requiring high overlay accuracy.

Although in principle the UV curable resin can be applied to the entire substrate surface, for instance by spin coating, this may be problematic due to the volatile nature of UV curable resins.

One approach to addressing this problem is the so-called ‘drop on demand’ process in which the resin is dispensed onto a target portion of the substrate in droplets immediately prior to imprinting with the template. The liquid dispensing is controlled so that a predetermined volume of liquid is deposited on a particular target portion of the substrate. The liquid may be dispensed in a variety of patterns and the combination of carefully controlling liquid volume and placement of the pattern can be employed to confine patterning to the target area.

Dispensing the resin on demand as mentioned is not a trivial matter. The size and spacing of the droplets are carefully controlled to ensure there is sufficient resin to fill template features while at the same time minimizing excess resin which can be rolled to an undesirably thick or uneven residual layer since as soon as neighboring drops touch the resin will have nowhere to flow.

Although reference is made above to depositing UV curable liquids onto a substrate, the liquids could also be deposited on the template and in general the same techniques and considerations will apply.

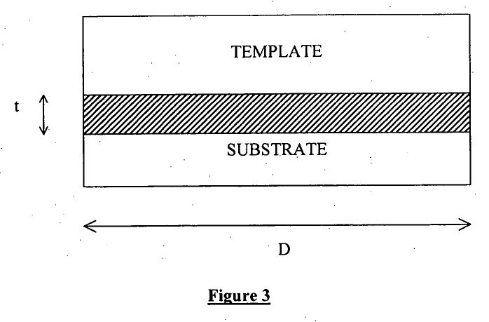

FIG. 3 illustrates the relative dimensions of the template, imprintable material (curable monomer, thermosetting resin, thermoplastic, etc.), and substrate. The ratio of the width of the substrate, D, to the thickness of the curable resin layer, t, is of the order of 10⁶. It will be appreciated that, in order to avoid the features projecting from the template damaging the substrate, the dimension t should be greater than the depth of the projecting features on the template.

The residual layer of imprintable material left after stamping is useful in protecting the underlying substrate, but may also impact obtaining high resolution and/or overlay accuracy. The first ‘breakthrough’ etch is isotropic (non-selective) and will thus to some extent erode the features imprinted as well as the residual layer. This may be exacerbated if the residual layer is overly thick and/or uneven.

This etching may, for instance, lead to a variation in the thickness of features ultimately formed on the underlying substrate (i.e. variation in the critical dimension). The uniformity of the thickness of a feature that is etched in the transfer layer in the second anisotropic etch is dependant upon the aspect ratio and integrity of the shape of the feature left in the resin. If the residual resin layer is uneven, then the non-selective first etch may leave some of these features with “rounded” tops so that they are not sufficiently well defined to ensure good uniformity of feature thickness in the second and any subsequent etch process.

In principle, the above problem may be reduced by ensuring the residual layer is as thin as possible but this may require application of undesirably large pressures (possibly increasing substrate deformation) and relatively long imprinting times (perhaps reducing throughput).

As noted above, the resolution of the features on the template surface is a limiting factor on the attainable resolution of features printed on the substrate. The templates used for hot and UV imprint lithography are generally formed in a two-stage process. Initially, the required pattern is written using, for example, electron beam writing to give a high resolution pattern in resist. The resist pattern is then transferred into a thin layer of chrome which forms the mask for the final, anisotropic etch step to transfer the pattern into the base material of the template. Other techniques such as for example ion-beam lithography, X-ray lithography, extreme UV lithography, epitaxial growth, thin film deposition, chemical etching, plasma etching, ion etching or ion milling could be used. Generally, a technique capable of very high resolution will be desired as the template is effectively a 1× mask with the resolution of the transferred pattern being limited by the resolution of the pattern on the template.

The release characteristics of the template are also a consideration. The template may, for instance, be treated with a surface treatment material to form a thin release layer on the template having a low surface energy (a thin release layer may also be deposited on the substrate).

Another consideration in the development of imprint lithography is the mechanical durability of the template. The template may be subjected to large forces during stamping of the imprintable medium, and in the case of hot imprint lithography, it may also be subjected to high pressure and temperature. The force, pressure and/or temperature may cause wearing of the template, and may adversely affect the shape of the pattern imprinted upon the substrate.

In hot imprint lithography, a potential advantage may be realized in using a template of the same or similar material to the substrate to be patterned in order to help reduce differential thermal expansion between the two. In UV imprint lithography, the template is at least partially transparent to the activation radiation and accordingly quartz templates are used.

Although specific reference may be made in this text to the use of imprint lithography in the manufacture of ICs, it should be understood that imprint apparatus and methods described may have other applications, such as the manufacture of integrated optical systems, guidance and detection patterns for magnetic domain memories, hard disk magnetic media, flat panel displays, thin-film magnetic heads, etc.

While in the description above particular reference has been made to the use of imprint lithography to transfer a template pattern to a substrate via an imprintable resin effectively acting as a resist, in some circumstances the imprintable material may itself be a functional material, for instance having a functionally such as conductivity, optical linear or non linear response, etc. For example, the functional material may form a conductive layer, a semiconductive layer, a dielectric layer or a layer having another desirable mechanical, electrical or optical property. Some organic substances may also be appropriate functional materials. Such applications may be within the scope of one or more embodiments of the invention.

As mentioned above, hot imprint lithography employing a thermoplastic imprintable medium may suffer from one or more problems. For example, since thermoplastic polymers typically exhibit relatively high viscosities, acceptable pattern formation in the imprintable medium usually requires the template to be subjected to a high pressure which may deform the imprintable medium and/or the substrate. Furthermore, because thermoplastic polymers are amorphous materials, they are typically heated to above their flow temperature prior to imprinting so that deformation caused by pressing the template into the polymer will be irreversible upon cooling back down to below their glass transition temperature. Thermoplastic polymers are therefore typically heated to at least 50° C. above their glass transition temperature prior to imprinting, which may lead to differential thermal expansion within the different components of the imprinting system. The high pressure and/or high temperature when using thermoplastic polymers may make high accuracy overlay of multiple layers difficult if not impossible.

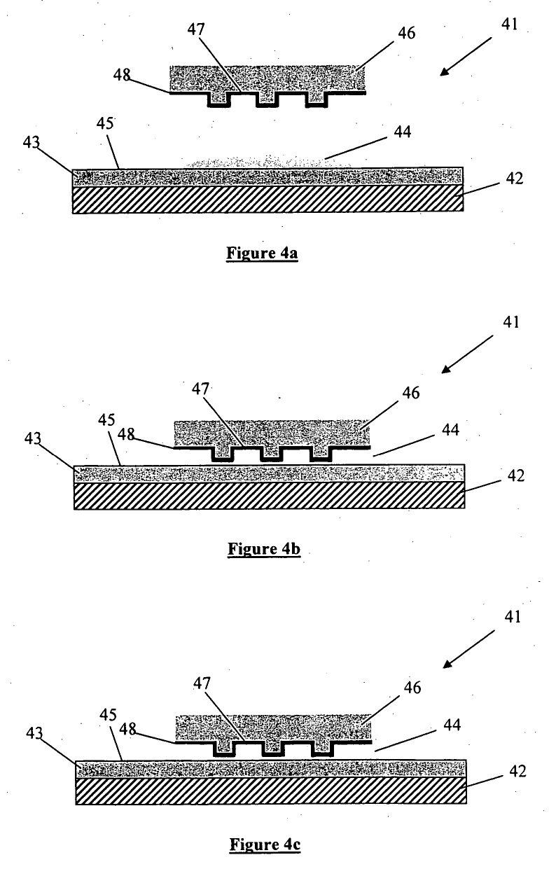

FIG. 4(a) shows the various components of an imprinting system 41 for use in accordance with an embodiment of the method of the invention. A silicon substrate 42 supports a planarization layer 43. A layer of a fully refined paraffin wax 44 has been deposited by, e.g., spin coating onto a surface 45 of the planarization layer 43 to act as an imprintable etch barrier. The substrate 42 and planarization layer 43 are maintained at a temperature a few degrees Centigrade below the melting point temperature of the wax 44 so that the wax 44 is maintained in a solid phase. Positioned above the paraffin wax 44 is a template 46 with a lower surface 47 which defines a relief pattern. A release layer 48 is coated on the surface 47 of the template 46 defining the relief pattern to aid in separation of the template 46 from the paraffin wax 44 following formation of the pattern in the solidified wax 44.

FIG. 4(b) shows the imprinting step. The substrate 42, planarization layer 43, template 46 and release layer 48 are heated and then maintained at a temperature a few degrees Centigrade above the melting point temperature of the wax 44 to liquefy the wax 44. The liquid wax 44 is then contacted and imprinted by the surface 47 of the template 46 defining the relief pattern so that the desired pattern is formed in the wax 44.

In FIG. 4(c), the substrate 42, planarization layer 43, template 46 and release layer 48 are cooled and then maintained at a temperature a few degrees Centigrade below the melting point temperature of the wax 44 to cool and resolidify the wax 44 while retaining the pattern imprinted in the previous step.

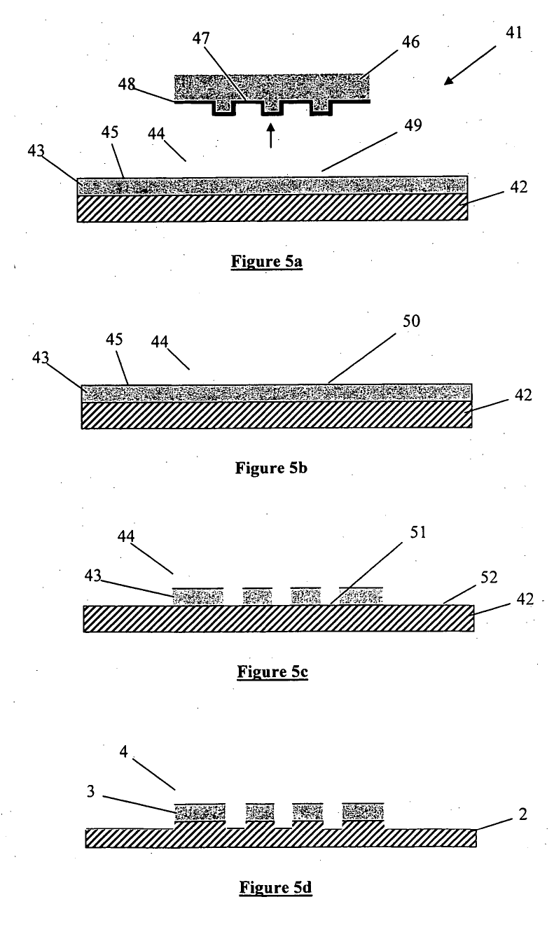

In FIG. 5(a), the template 46 and release layer 48 are separated from the solidified wax 44 leaving areas of reduced thickness 49 in the wax 44 adjacent the surface 45 of the planarization layer 43. FIG. 5(b) shows a first etching process to remove the areas of reduced thickness 49 in the solidified wax 44 thereby exposing regions 50 of the surface 45 the planarization layer 43. In FIG. 5(c), the exposed regions 50 of the surface 45 of the planarization layer 43 are etched to expose regions 51 of a surface 52 of the substrate 42. In FIG. 5(d), the exposed regions 51 of the surface 52 of the substrate are etched to provide the desired pattern in the substrate 42.

Since the imprintable medium comprises a crystalline or polycrystalline material the temperature changes required to liquefy the medium ready for imprinting and resolidify it ready for removal of the template are significantly lower than those required for the analogous steps when using a thermoplastic polymer. The imprinting rate should therefore be increased, and heat flow and differential thermal expansion throughout the imprinting system should be reduced thereby providing an improvement in imprint resolution and overlay accuracy. Additionally, phase transitions between the solid and liquid states should be more accurately reproducible and more accurately tailorable to suit a given application.

There are several different sources of temperature variations during imprint lithography, e.g. heating during UV illumination, energy release during curing, and intrinsic temperature variations within the system (such as temperature changes as the substrate is transferred from the process machine to the lithography machine). Such temperature variations typically result in thermal expansion of the imprintable medium which can lead to feature size variations in the imprinted pattern.

Feature size variations can be measured by any appropriate conventional technique, for example, by measuring the line spacing between specially designed marks on the template and the substrate. Thus, as feature size variations occur, they can be measured and corrected. One way to correct feature size variations is to pre-heat and maintain the template at a predefined temperature (e.g., by infrared radiation or with the use of a heating element) before the imprint process begins. Any heat released during the imprinting process (e.g., by UV-induced curing of the imprintable medium), which would otherwise cause the template to expand can be compensated for by reducing the extent to which the template is heated (e.g., by reducing the flux of the infrared radiation) during imprinting. In doing so, the total heat load to transferred to the template may be held constant and thereby avoid temperature induced pattern feature variations.

In an embodiment, pre-heating may be unnecessary if known negative expansion coefficient materials are employed which shrink on heating. Accurate feature size control may then be obtained by a suitable arrangement of different materials, including one or more negative expansion coefficient materials. For example, a multilayer structure could be employed utilizing at least one layer made of a negative expansion coefficient material.

In a further embodiment, temperature induced feature variations may be avoided by pre-stretching of the template using suitably arranged piezo elements attached to the template. Thermally induced expansion of the template during imprinting may be compensated for by appropriate control of the piezo elements. For example, a temperature change within the system (e.g., during exothermic curing of the imprintable medium) which induces expansion of the template may be compensated for by changing the voltage applied to the piezo elements to shrink the template back to its appropriate form.

It will be understood that numerous modifications can be made to the one or more embodiments described above without departing from the underlying inventive concept and that these modifications are intended to be included within the scope of the invention. For example, the imprintable medium may comprise one or more imprint materials in any desirable ratio. The imprintable medium may also contain one or more additives to act as nucleating agents or to adjust the physical and/or chemical properties of the medium, such as viscosity or latent heat of fusion. One or more embodiments of the method may be applied to imprint systems using any desirable substrate material with or without a planarization layer. Moreover, the use of a release layer is not mandatory and may be omitted if appropriate. Since many crystallization and polycrystalline materials exhibit relatively low viscosities, sticking of the imprintable medium to the template during separation may be reduced by use of a method in accordance an embodiment of the invention.

The skilled person will readily appreciate that one or more embodiments of the invention are suitable for the production of multilayer substrates by simply repeating the above described procedure on successive layers of substrate material. Moreover, since crystalline and polycrystalline materials generally exhibit low viscosities, relatively low printing pressures may be used. This may reduce the likelihood of substrate deformation during processing and thereby improve the accuracy of pattern overlay.

While specific embodiments of the invention have been described above, it will be appreciated that the invention may be practiced otherwise than as described. The description is not intended to limit the invention.

1. An imprinting method, comprising:
subjecting an imprintable medium on a substrate to conditions such that the medium is at a first temperature so that it is in a flowable state, the imprintable medium comprising an imprint material selected from a group consisting of: a crystalline material, a polycrystalline material and a wax;
pressing a template into the medium to form an imprint in the medium;
cooling the medium to a second temperature such that the medium is in a substantially non-flowable state while the medium is contacted by the template; and
separating the template from the medium while in the substantially non-flowable state.

2. The method according to claim 1, wherein the medium is heated to the first temperature immediately before the template is pressed into the medium.

3. The method according to claim 1, wherein the medium is heated to the first temperature immediately after the medium is contacted by the template.

4. The method according to claim 1, comprising depositing a first volume of the medium on a first target portion of the substrate and imprinting the first volume of the medium.

5. The method according to claim 4, wherein following imprinting of the first volume of the medium, depositing a second volume of the medium on a second target portion of the substrate which is spaced from the first target portion and imprinting the second volume of the medium.

6. The method according to claim 1, wherein the first temperature is equal to or greater than the melting point temperature of the medium.

7. The method according to claim 1, wherein the first temperature is up to 10° C. above the melting point temperature of the medium.

8. The method according to claim 1, wherein the second temperature is equal to or less than the melting point temperature of the medium.

9. The method according to claim 1, wherein the second temperature is up to 10° C. below the melting point temperature of the medium.

10. The method according to claim 1, wherein the medium is in a solid phase when the template initially contacts the medium.

11. The method according to claim 1, wherein the medium is in a liquid phase when the template initially contacts the medium.

12. The method according to claim 1, wherein the medium is in a solid phase immediately before the template is separated from the medium.

13. The method according to claim 1, wherein the medium is converted from a liquid phase to a solid phase while the medium is contacted by the template.

14. The method according to claim 1, wherein the medium is provided on the substrate by a method selected from a group consisting of: casting, spray coating and spin coating.

15. The method according to claim 1, wherein a pressure in the range of 10 to 100 kPa is applied to the template during contacting the medium with the template.

16. The method according to claim 1, wherein the imprint material has a melting point temperature close to room temperature.

17. The method according to claim 1, wherein the imprint material has a melting point temperature in the range of 20 to 100° C.

18. The method according to claim 1, wherein the imprint material has a viscosity of less than 100 cps.

19. The method according to claim 1, wherein the imprint material comprises silicon containing groups.

20. The method according to claim 1, wherein the latent heat of fusion of the imprint material is less than 150 J/g.

21. The method according to claim 1, wherein the imprint material comprises a hydrocarbon compound.

22. The method according to claim 21, wherein the hydrocarbon compound contains at least 15 carbon atoms.

23. The method according to claim 21, wherein the hydrocarbon compound contains 15 to 40 carbon atoms.

24. The method according to claim 21, wherein the hydrocarbon compound is selected from the group consisting of: an aliphatic hydrocarbon, a branched hydrocarbon, an alicyclic hydrocarbon and an aromatic hydrocarbon.

25. The method according to claim 21, wherein the hydrocarbon compound is an alkane.

26. The method according to claim 1, wherein the imprint material comprises a paraffin wax.

27. The method according to claim 26, wherein the paraffin wax has a melting point temperature in the range of 20 to 90° C.

28. The method according to claim 27, wherein the paraffin wax is represented by the formula CₙH₂ₙ₊₂ where 15≦n≦40.

29. The method according to claim 1, wherein the imprint material comprises a microcrystalline wax.

30. The method according to claim 29, wherein the microcrystalline wax has a melting point temperature in the range of 40 to 110° C.

31. The method according to claim 29, wherein the microcrystalline wax is represented by the formula CₙH₂ₙ₊₂ where 15≦n≦40.

32. The method according to claim 1, wherein the imprintable medium comprises a nucleating species selected from the group consisting of: an oxide, a nitride, a halide and a hydroxide.

33. The method according to claim 32, wherein the nucleating species is selected from the group consisting of: Al₂O₃, BN, KBr, CaBr₂.6H₂O, Na₂[B₄O₅(OH)₄]. 10H₂O, BaO, NiCl₂.6H₂O, Ba(OH)₂ and Ba(OH)₂.8H₂O.

34. The method according to claim 1, wherein pressing a template into the medium forms an area of reduced thickness in the imprintable medium and further comprising etching the area of reduced thickness to expose a region of a surface of the substrate.

35. The method according to claim 34, further comprising etching the exposed region of the surface of the substrate.

36. The method according to claim 1, wherein an intermediate layer is provided between the substrate and the imprintable medium.

37. The method according to claim 36, wherein pressing a template into the medium forms an area of reduced thickness in the imprintable medium and further comprising etching the area of reduced thickness to expose a region of a surface of the intermediate layer.

38. The method according to claim 37, further comprising etching the exposed region of the surface of the intermediate layer to expose a region of a surface of the substrate.

39. The method according to claim 38, further comprising etching the exposed region of the surface of the substrate.

40. A method for patterning a substrate, comprising:
subjecting an etch barrier material on a substrate to conditions such that the etch barrier material is at a first temperature so it is in a flowable state, the etch barrier material comprising an imprint material selected from a group consisting of: a crystalline material, a polycrystalline material and a wax;
pressing a template into the etch barrier material to form a pattern comprising an area of reduced thickness in the etch barrier material;
cooling the etch barrier material to a second temperature such that the etch barrier material is in a substantially non-flowable state while the etch barrier material is contacted by the template;
separating the template from the etch barrier material while in the substantially non-flowable state;
etching the area of reduced thickness to expose a region of a surface of the substrate; and
etching the exposed region of the surface of the substrate.

41. The method according to claim 40, wherein the etch barrier material is heated to the first temperature immediately before the template is pressed into the etch barrier material.

42. The method according to claim 40, wherein the etch barrier material is heated to the first temperature immediately after the etch barrier material is contacted by the template.

43. The method according to claim 40, comprising depositing a first volume of the etch barrier material on a first target portion of the substrate and etching the surface of the first target portion of the substrate.

44. The method according to claim 43, wherein following etching of the surface of the first target portion of the substrate, depositing a second volume of the etch barrier material on a second target portion of the substrate which is spaced from the first target portion and etching the surface of the second target portion of the substrate.

45. The method according to claim 40, wherein the first temperature is equal to or greater than the melting point temperature of the etch barrier material.

46. The method according to claim 40, wherein the first temperature is up to 10° C. above the melting point temperature of the etch barrier material.

47. The method according to claim 40, wherein the second temperature is equal to or less than the melting point temperature of the etch barrier material.

48. The method according to claim 40, wherein the second temperature is up to 10° C. below the melting point temperature of the etch barrier material.

49. The method according to claim 40, wherein the etch barrier material is in a solid phase when the template initially contacts the etch barrier material.

50. The method according to claim 40, wherein the etch barrier material is in a liquid phase when the template initially contacts the etch barrier material.

51. The method according to claim 40, wherein the etch barrier material is in a solid phase immediately before the template is separated from the etch barrier material.

52. The method according to claim 40, wherein the etch barrier material is converted from a liquid phase to a solid phase while the etch barrier material is contacted by the template.

53. The method according to claim 40, wherein the etch barrier material is provided on the substrate by a method selected from a group consisting of: casting, spray coating and spin coating.

54. The method according to claim 40, wherein a pressure in the range of 10 to 100 kPa is applied to the template during contacting the etch barrier material with the template.

55. An imprintable medium comprising a crystalline imprint material for use in an imprint lithography process.

56. The medium according to claim 55, wherein the crystalline imprint material has a melting point temperature close to room temperature.

57. The medium according to claim 55, wherein the imprint material has a viscosity of less than 100 cps.

58. The medium according to claim 55, wherein the imprint material comprises silicon containing groups.

59. An imprintable medium comprising a polycrystalline imprint material for use in an imprint lithography process.

60. The medium according to claim 59, wherein the polycrystalline imprint material has a melting point temperature close to room temperature.

61. The medium according to claim 59, wherein the imprint material has a viscosity of less than 100 cps.

62. The medium according to claim 59, wherein the imprint material comprises silicon containing groups.
